(19) United States
(12) Patent Application Publication
(10) Pub. No.: US 2013/0091067 A1
(43) Pub. Date: Apr. 11, 2013

(54) System and a Method for Matching Members

(71) Applicant: Jason Barton, Temecula, CA (US)

(72) Inventor: Jason Barton, Temecula, CA (US)

(21) Appl. No.: 13/253,714

(22) Filed: Oct. 5, 2011

(51) Int. Cl. G06Q 99/00

(52) U.S. Cl. 705/319

(57) ABSTRACT

A system and a method for matching members where the system comprises a database being configured for at least storing information obtained from registered members seeking to be matched with other registered members. A server executes a computer-executable program being configured for processing information from said database and identifying potential matches of registered members. A client executes a computer-executable application being configured for presenting the potential matches and information of the matched members to users electing to vote on a likelihood of successes of the matches. Said computer-executable application is further configured for transferring votes to said database to be processed by said computer-executable program for aggregating votes and maintaining statistical values. Said computer-executable application is further configured for presenting, to a registered member, identified potential matches for the member and statistical values indicating likelihood of successes of the matches.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to social networking systems. More particularly, the invention relates to a system for matching pairs via a community of voters.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Conventional systems for performing matching associated with relationship development use a multiplicity of methods for performing potential matching. As an example, some relationship development systems use a compatibility calculation performed using personal information provided by users. Users may provide information such as beliefs, values, emotional health and skills. Furthermore, conventional systems may use a number of variables associated with the provided information in order to perform analysis for compatibility between users.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A illustrates an example GUI presentation, in accordance with an embodiment of the present invention;

FIG. 1B illustrates example GUI presentation as described with reference to FIG. 1A with addition of a pop-up presentation, in accordance with an embodiment of the present invention;

FIG. 2 illustrates an example GUI presentation, in accordance with an embodiment of the present invention;

FIG. 3A illustrates an example GUI presentation, in accordance with an embodiment of the present invention;

FIG. 3B illustrates an example GUI presentation as described with reference to FIG. 3A with addition of a pop-up presentation, in accordance with an embodiment of the present invention;

FIG. 3C illustrates an example GUI presentation as described with reference to FIG. 3A with addition of a profile presentation, in accordance with an embodiment of the present invention;

FIG. 3D illustrates an example GUI presentation as described with reference to FIG. 3A with addition of an inbox presentation, in accordance with an embodiment of the present invention;

FIG. 4 illustrates a block diagram depicting a conventional client/server communication system;

FIG. 5 illustrates an example method for operation of system for interacting with members and voters and for processing associated information, in accordance with an embodiment of the present invention; and

FIG. 6 illustrates a typical computer system that, when appropriately configured or designed, may serve as a computer system for which the present invention may be embodied.

Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention will be described which provide means and methods for a system for matching users with regard to dating, romantic relationships or other types of relationships. Furthermore, system processes selection information received from voters for matching users. System provides quality potential matches to a user for viewing and selection. System uses aggregated opinions of the broad community of voters for providing potential matches with regard to developing a relationship with a high probability of success.

System enables voters to enter a selection associated with their opinion as to whether presented candidates are considered a potential match.

System receives and stores votes by selected by voters. Furthermore, system processes the received votes to generate an aggregate statistical representation for the likelihood of a match. As a non-limiting example, the aggregate statistical representation may be calculated as an average. The aggregate statistical representations for the various potential matches associated with a user are ranked with respect to the highest probability for a successful match.

Voters view photographs, videos and other personal information associated with users for making a selection. Users may then access their account for viewing the statistically ranked potential matches. Voters are not required to have an account. Voters may be users not looking for a match, but are willing to express an opinion as to whether presented candidates are considered a potential match. Furthermore, users that have an account are not required to vote.

System may even out the user gender imbalance by nature of the aggregated statistical data used for ranking and selecting potential matches. The system by means of creating matches based on a statistical average generated by multiple voters voting on the potential match of two people, means individual members will not be contacted by too little, or too many other members of the opposite gender because the system provides the aggregated matches, not the users themselves.

System provides the capability to process large amounts of statistical information for generating potential matches to aid in relationship development.

System provides entertainment value which aids in developing a large community of voters.

System provides a website with a series of associated web pages for interaction with globally connected conventional computing devices. Furthermore, website provides mobile applications for globally connected mobile communication devices.

System supports interactive communications between users. Non-limiting examples for users include members and voters. Members may create an account with the intent of finding potential relationship matches. Voters select potential relationship matches for members. Members enter personal information into system via website or other internet enabled application, such as, but not limited to, an application on a mobile device. Non-limiting examples of entered information include gender, religion, geographic location, relationship goals, income and age. Members may also enter information associated with characteristics for potential matches. Non-limiting examples of characteristic information members may enter for potential matches include age, geographic location, religious preference and income. Furthermore, members may specify an importance level associated with the entered characteristic information. As a non-limiting example, members may specify an importance level for a characteristic on a scale from 1 to 5. Members may upload and store digital pictures/images, videos, text and other information to system for viewing by other members and voters.

System presents two members to a voter for making a match selection. System presents the two members based upon the characteristics entered by the respective members. Initially, a brief amount of information provided by the members is presented to voter (e.g. picture, video, text, etc). Voter may select and browse additional detailed information associated with members for viewing. Voter performs a match compatibility selection for the two members. As a non-limiting example, voter makes selection based on a rank order scale from 1 to 5.

After performing match compatibility selection, additional pairs of members may be presented to voter for performing match compatibility selection. Furthermore, voter may continue performing match compatibility selection until voter decides to terminate performing match compatibility selection process.

System processes the selections performed by the voter community for determining potential matches based upon statistical analysis. A non-limiting example of a statistical analysis performed is an average of the voter selections.

Following system processing voter selections, a member may view the top recommendations as processed by the system. A member may initiate communication with a top recommendation or a multiplicity of top recommendations. A member may also be presented with and view communications from other members.

After initial contact, members may continue to communicate via the system or view alternate avenues.

A member receiving communication from another member may be notified of the communication. Non-limiting examples for performing communication include alert from system via a Graphical User Interface (GUI) device, email message and text message.

A member may select to block other members from communicating with member. Members may also select to reset their profile information and reset their ranking.

System may be applied to other applications where a community at large can vote collectively in order to produce a rank order statistical average for performing a potential match between a person and another entity. As a non-limiting example, the system may be used for matching a prospective employee with a prospective employer.

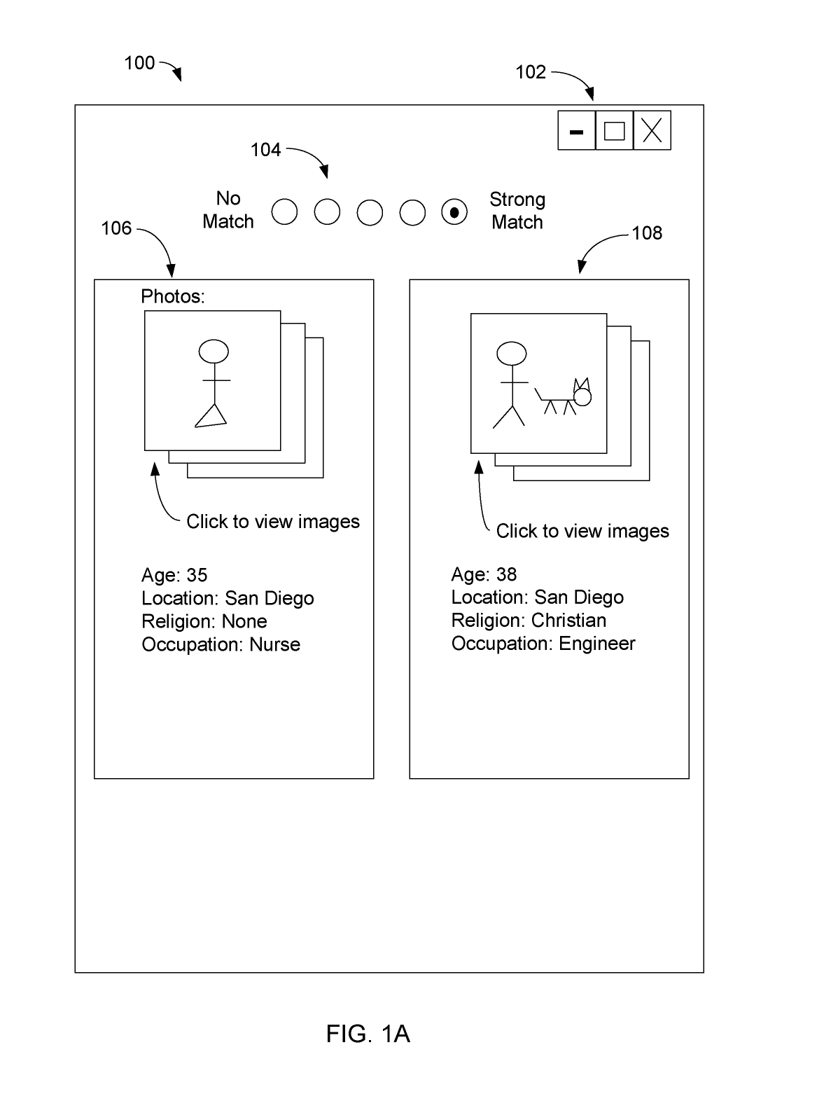

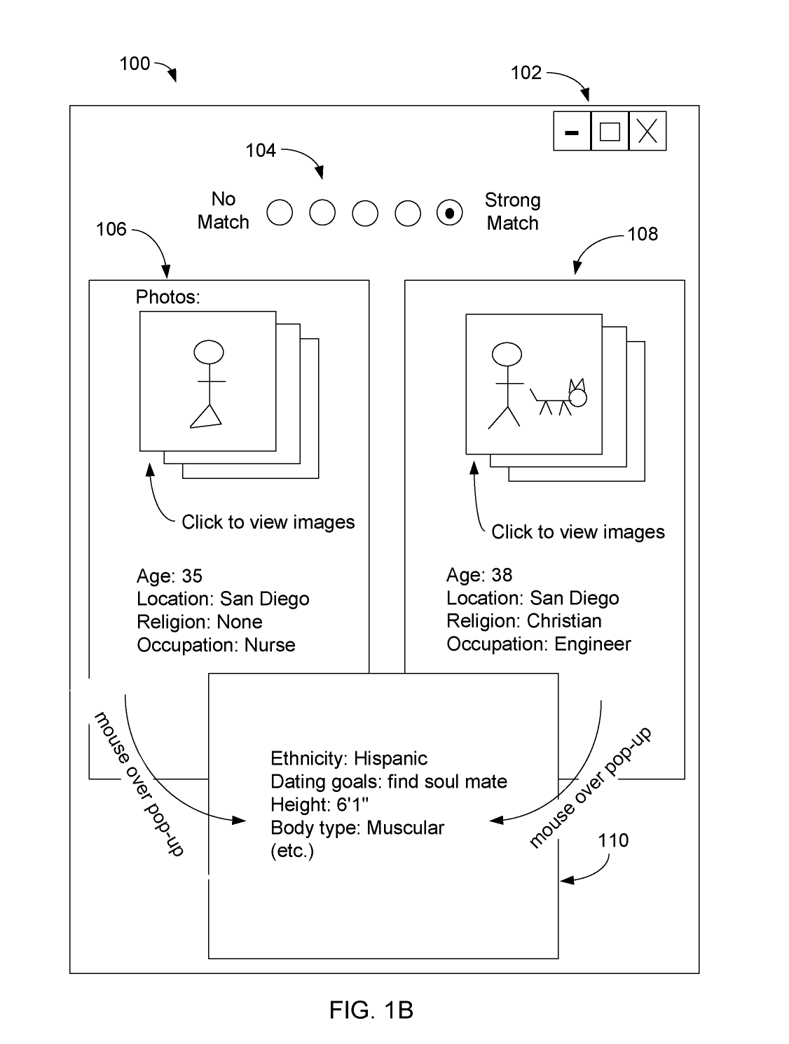

FIG. 1A illustrates an example GUI presentation, in accordance with an embodiment of the present invention.

A GUI presentation 100 includes a presentation control portion 102, a selection portion 104, an information presentation portion 106 and an information presentation portion 108. Users are self-compelled to vote for entertainment and for the desire to help other people find matches.

Presentation control portion 102 enables control of GUI presentation 100. Non-limiting examples of control performed include minimizing GUI presentation 100, maximizing GUI presentation 100, reducing GUI presentation 100 and closing GUI presentation 100.

Selection portion 104 enables selection associated with a potential match. Non-limiting examples for selection include no potential match and strong potential match.

Information presentation portion 106 provides information associated with a first person. Non-limiting examples of information presented include picture, images, videos, chronological age, geographic location and occupation.

Information presentation portion 108 provides information associated with a second person. Non-limiting examples of information presented include picture, images, videos, chronological age, geographic location and occupation.

In operation, a user may select to configure GUI presentation 100 via presentation control portion 102. Furthermore, a user may view information associated with information presentation portion 106 and information presentation portion 108 for determining a potential match between first presented via information presentation portion 106 and second person presented via information presentation portion 108. Based upon the analysis of user, user may configure selection portion 104 based on the analysis. For example, if user considers the two persons as not compatible, then user may configure selection portion 104 for “no potential match”. As another example, if user considers the two persons as compatible, then user may configure selection portion 104 for “strong potential match”. As another example, if user considers the two persons as somewhat compatible, then user may configure selection portion 104 for somewhere between “no potential match” and “strong potential match”.

FIG. 1B illustrates example GUI presentation as described with reference to FIG. 1A with addition of a pop-up presentation, in accordance with an embodiment of the present invention.

Moving a control device (e.g. mouse, trackball, etc.) over information presentation portion 106 or information presentation portion 108 presents a pop-up presentation portion 110.

Moving control device over information presentation portion 106 provides information via pop-up presentation portion 110 associated with first person with regard to information presentation portion 106.

Moving control device over information presentation portion 108 provides information via pop-up presentation portion 110 associated with second person with regard to information presentation portion 108.

Non-limiting examples of information presented via pop-up presentation portion 110 include ethnicity, dating goals, height and body type.

FIG. 1B illustrates example GUI presentation as described with reference to FIG. 1A with a pop-up presentation where further information may be presented with a person.

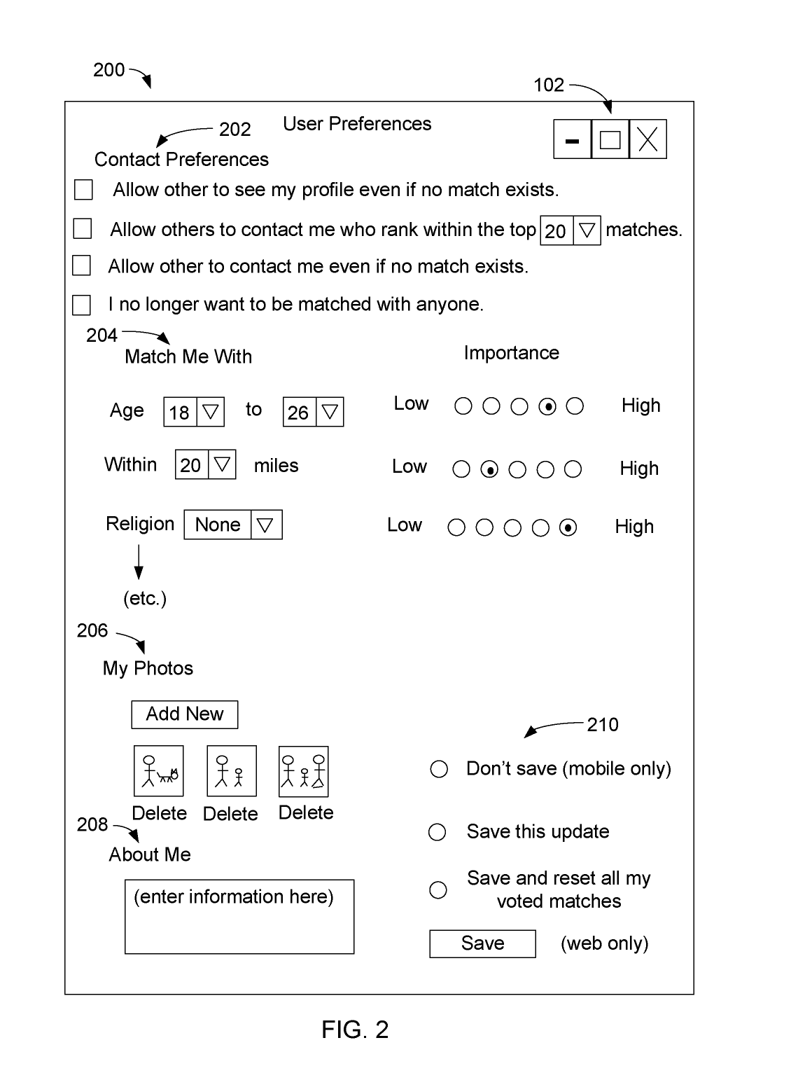

FIG. 2 illustrates an example GUI presentation, in accordance with an embodiment of the present invention.

A GUI presentation 200 includes presentation control portion 102, a contact preferences portion 202, a potential match configuration portion 204, a photos portion 206, an information entry portion 208 and a save control portion 210.

Contact preferences portion 202 provides configuration for access by third parties. Non-limiting examples for contact preferences portion 202 include allowing others to view profile without a potential match, allowing others to contact user within a certain rank constraint, allowing other to contact user without a potential match and choosing to not be contacted by any third parties. The system by means of creating matches based on a statistical average generated by multiple voters voting on the potential match of two people, means individual members will not be contacted by too little, or too many other members of the opposite gender because the system provides the aggregated matches, not the users themselves.

Potential match configuration portion 204 provides configuration information for system with regard to performing potential match processing. Non-limiting examples for match parameters include an age range, a distance range and a religious preference. Furthermore, match parameters may be configured based upon a range from low to high.

Photos portion 206 enables a user to add and remove digital images, video presentations, etc. for viewing.

Information entry portion 208 enables a user to add textual information for presentation. GUI presentation 200 may provide for additional entry portions for entry of other categorical information such as, but not limited to, user age, location etc. The additional entry portions may be on a separate page from contact preferences.

Save control portion 210 provides configuration for saving information associated with GUI presentation 200. Non-limiting examples for configuring saving of information includes saving information, not saving information when associated with mobile devices and saving information and resetting potential matches.

FIG. 2 illustrates an example GUI presentation for configuring contact preferences, configuring match parameters, adding and removing digital images, entering text information for viewing and saving information.

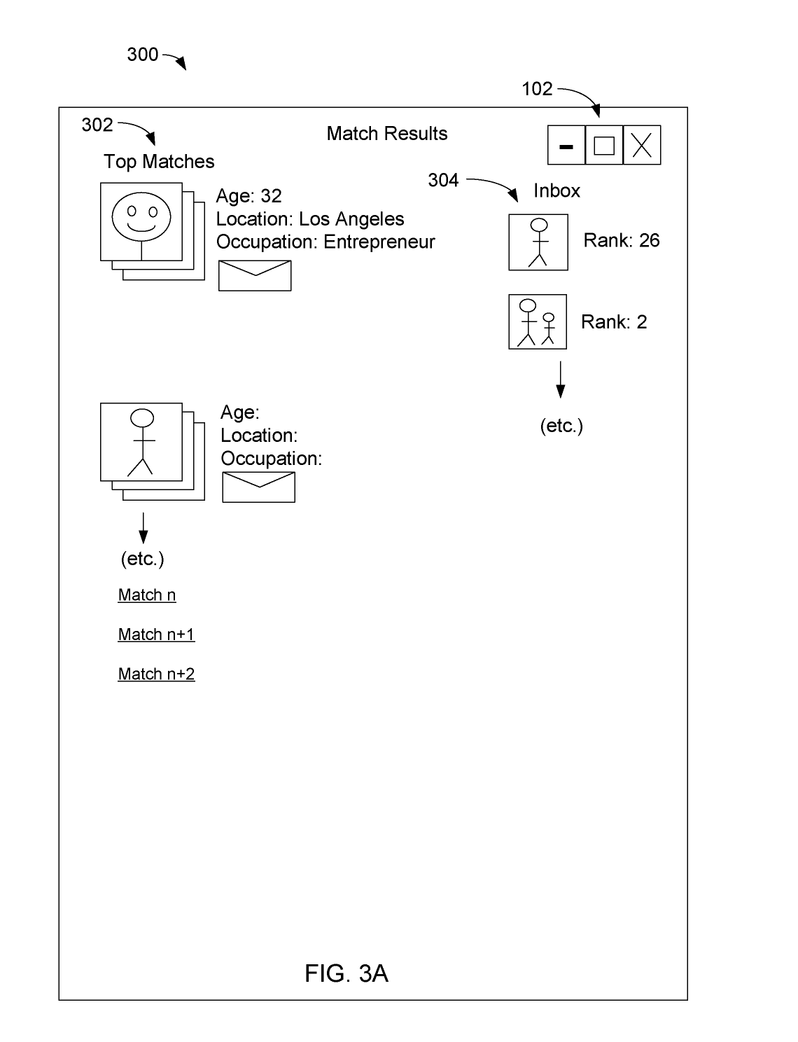

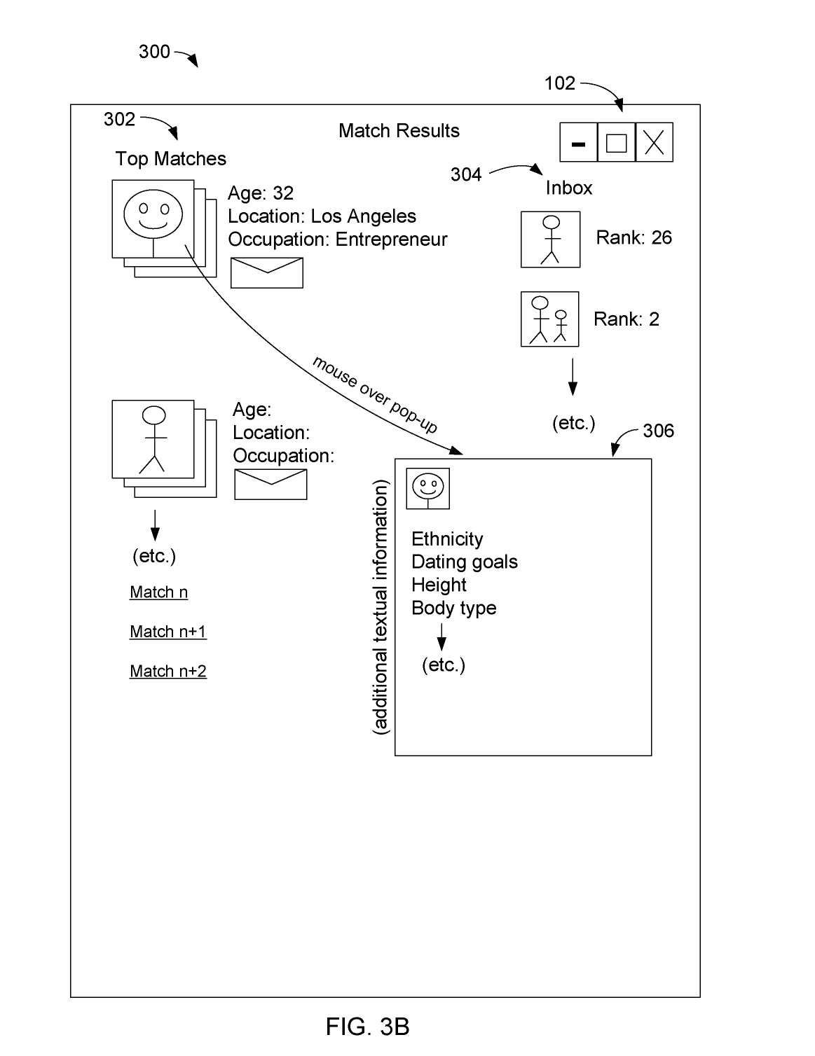

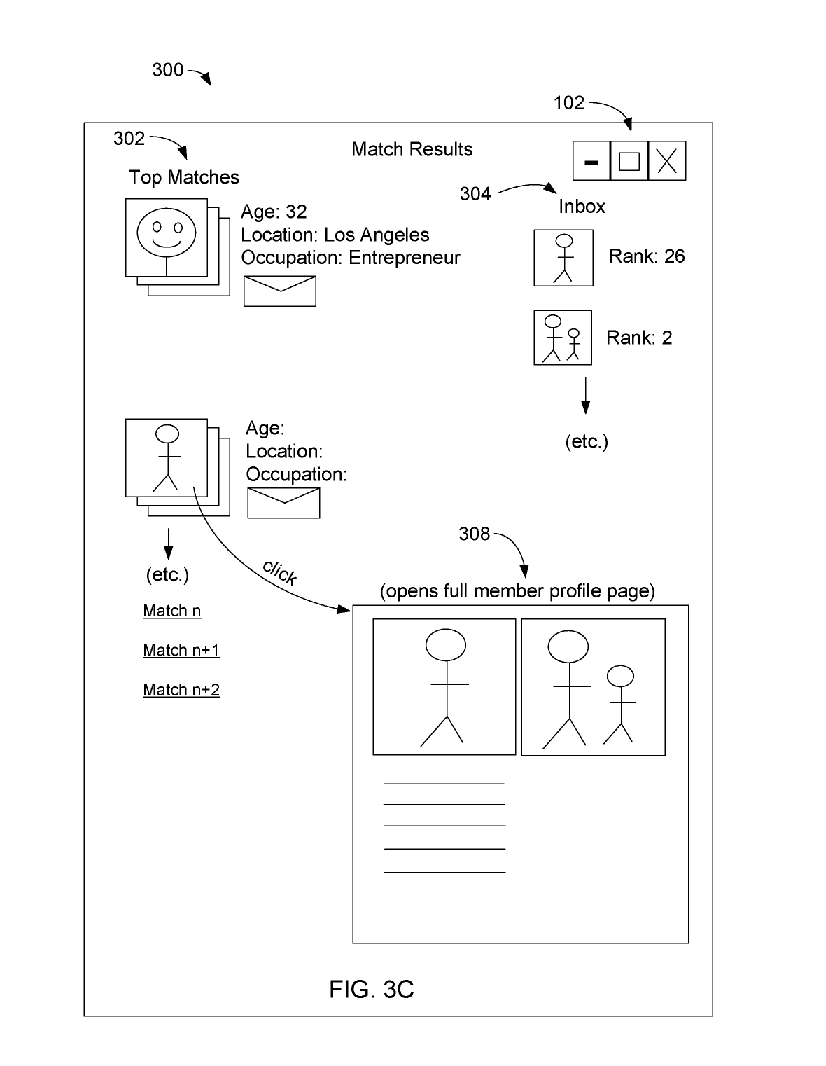

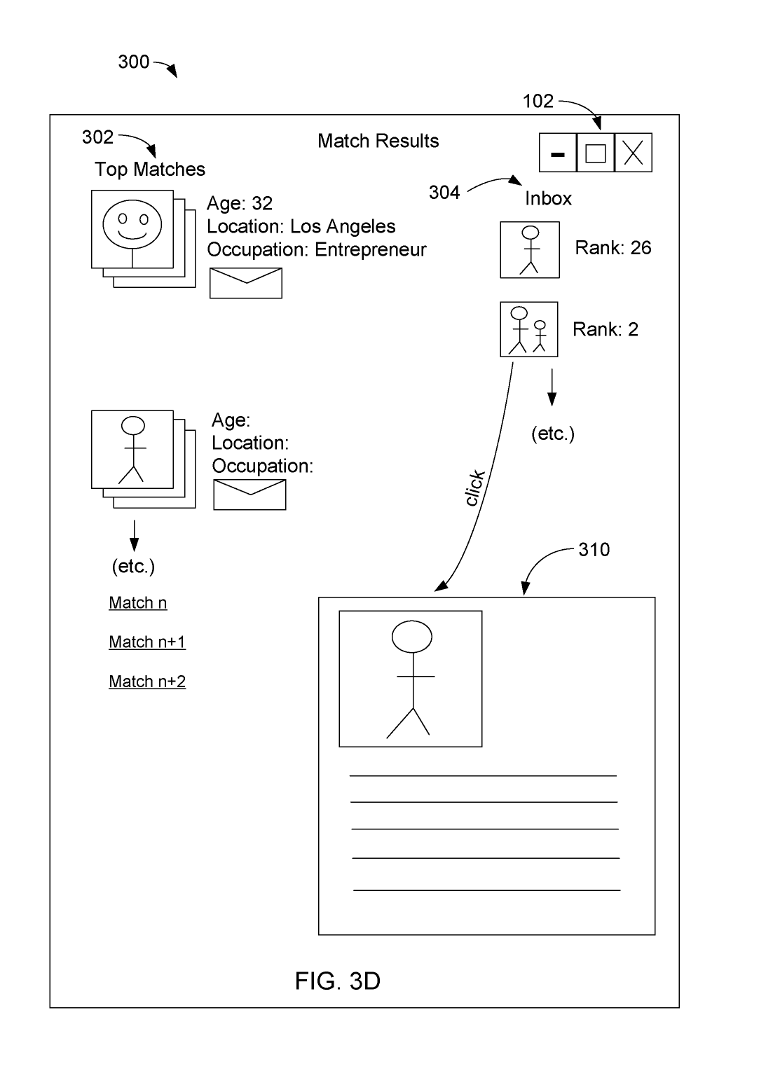

FIG. 3A illustrates an example GUI presentation, in accordance with an embodiment of the present invention.

A GUI presentation 300 includes presentation control portion 102, a top potential matches portion 302 and an inbox portion 304.

Top potential matches portion 302 presents potential matches as determined by the system based upon selections performed by voters. Non-limiting examples of information presented via top potential matches portion 302 include digital images, chronological age, geographic location, occupation and correspondence from potential matches. Potential match information may be sorted based upon a match ranking parameter. As a non-limiting example, potential matches with a higher match ranking parameter may be presented in a location higher up with respect to GUI presentation 300.

Inbox portion 304 presents received communication correspondence from third parties. As a non-limiting example, inbox portion 304 may include digital images, videos and textual information. Information presented via inbox portion 304 may be presented based upon a matching rank parameter. As a non-limiting example, correspondence from higher ranking potential matches may be presented in a location higher up with respect to GUI presentation 300. As another non-limiting example, correspondence may be presented chronologically.

FIG. 3A illustrates an example GUI presentation where information associated with potential matches may be presented.

FIG. 3B illustrates an example GUI presentation as described with reference to FIG. 3A with addition of a pop-up presentation, in accordance with an embodiment of the present invention.

A pop-up presentation 306 may be presented via a control device being geographically placed over, but not selecting, top potential matches portion 302. Non-limiting examples of information presented via pop-up presentation 306 include digital images, ethnicity, dating goals, height and body type.

FIG. 3B illustrates an example GUI presentation as described with reference to FIG. 3A with addition of a pop-up presentation displaying additional information associated with a potential match.

FIG. 3C illustrates an example GUI presentation as described with reference to FIG. 3A with addition of a profile presentation, in accordance with an embodiment of the present invention.

A profile presentation 308 may be presented via selection of top potential matches portion 302. Profile presentation 308 provides information associated with a potential match's profile page. Non-limiting examples of information provided by profile presentation 308 include digital images, audio, video, textual information and biographical information.

FIG. 3C illustrates an example GUI presentation as described with reference to FIG. 3A with addition of a profile presentation presenting information associated with a potential match's profile.

FIG. 3D illustrates an example GUI presentation as described with reference to FIG. 3A with addition of an inbox presentation, in accordance with an embodiment of the present invention.

An inbox presentation 310 may be presented via selection of inbox portion 304. Inbox presentation 310 provides information associated with correspondence received from an external entity. Non-limiting examples of information presented include digital image, video and text.

FIG. 3D illustrates an example GUI presentation as described with reference to FIG. 3A with addition of an inbox presentation presenting correspondence information associated with a potential match.

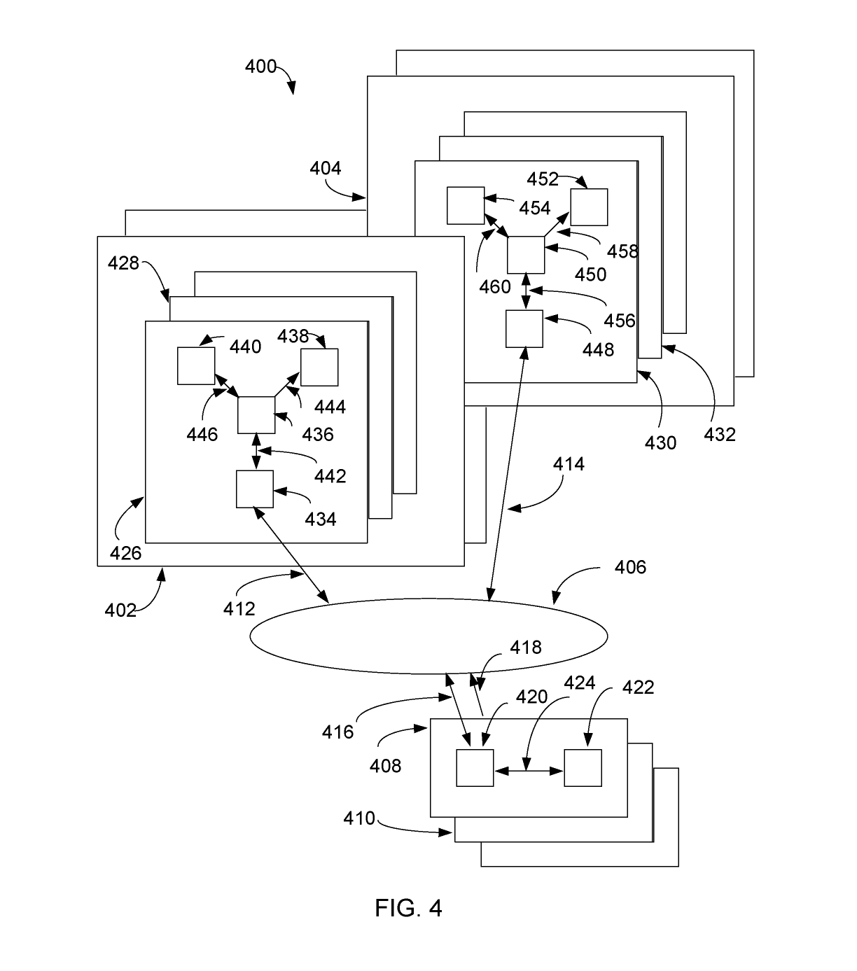

FIG. 4 illustrates a block diagram depicting a conventional client/server communication system.

A communication system 400 includes a multiplicity of networked regions with a sampling of regions denoted as a network region 402 and a network region 404, a global network 406 and a multiplicity of servers with a sampling of servers denoted as a server device 408 and a server device 410.

Network region 402 and network region 404 may operate to represent a network contained within a geographical area or region. Non-limiting examples of representations for the geographical areas for the networked regions may include postal zip codes, telephone area codes, states, counties, cities and countries. Elements within network region 402 and 404 may operate to communicate with external elements within other networked regions or within elements contained within the same network region.

In some implementations, global network 406 may operate as the Internet. It will be understood by those skilled in the art that communication system 400 may take many different forms. Non-limiting examples of forms for communication system 400 include local area networks (LANs), wide area networks (WANs), wired telephone networks, cellular telephone networks or any other network supporting data communication between respective entities via hardwired or wireless communication networks. Global network 406 may operate to transfer information between the various networked elements.

Server device 408 and server device 410 may operate to execute software instructions, store information, support database operations and communicate with other networked elements. Non-limiting examples of software and scripting languages which may be executed on server device 408 and server device 410 include C, C++, C# and Java.

Network region 402 may operate to communicate bi-directionally with global network 406 via a communication channel 412. Network region 404 may operate to communicate bi-directionally with global network 406 via a communication channel 414. Server device 408 may operate to communicate bi-directionally with global network 406 via a communication channel 416. Server device 410 may operate to communicate bi-directionally with global network 406 via a communication channel 418. Network region 402 and 404, global network 406 and server devices 408 and 410 may operate to communicate bi-directionally and also communicate bi-directionally with other networked device located within communication system 400.

Server device 408 includes a networking device 420 and a server 422. Networking device 420 may operate to communicate bi-directionally with global network 406 via communication channel 416 and with server 422 via a communication channel 424. Server 422 may operate to execute software instructions and store information.

Network region 402 includes a multiplicity of clients with a sampling denoted as a client 426 and a client 428. Client 426 includes a networking device 434, a processor 436, a GUI 438 and an interface device 440. Non-limiting examples of devices for GUI 438 include monitors, televisions, cellular telephones, smartphones and PDAs (Personal Digital Assistants). Non-limiting examples of interface device 440 include pointing device, mouse, trackball, scanner and printer. Networking device 434 may communicate bi-directionally with global network 406 via communication channel 412 and with processor 436 via a communication channel 442. GUI 438 may receive information from processor 436 via a communication channel 444 for presentation to a user for viewing. Interface device 440 may operate to send control information to processor 436 and to receive information from processor 436 via a communication channel 446. Network region 404 includes a multiplicity of clients with a sampling denoted as a client 430 and a client 432. Client 430 includes a networking device 448, a processor 450, a GUI 452 and an interface device 454. Non-limiting examples of devices for GUI 438 include monitors, televisions, cellular telephones, smartphones and PDAs (Personal Digital Assistants). Non-limiting examples of interface device 440 include pointing devices, mousse, trackballs, scanners and printers. Networking device 448 may communicate bi-directionally with global network 406 via communication channel 414 and with processor 450 via a communication channel 456. GUI 452 may receive information from processor 450 via a communication channel 458 for presentation to a user for viewing. Interface device 454 may operate to send control information to processor 450 and to receive information from processor 450 via a communication channel 460.

For example, consider the case where a user interfacing with client 426 may want to execute a networked application. A user may enter the IP (Internet Protocol) address for the networked application using interface device 440. The IP address information may be communicated to processor 436 via communication channel 446. Processor 436 may then communicate the IP address information to networking device 434 via communication channel 442. Networking device 434 may then communicate the IP address information to global network 406 via communication channel 412. Global network 406 may then communicate the IP address information to networking device 420 of server device 408 via communication channel 416. Networking device 420 may then communicate the IP address information to server 422 via communication channel 424. Server 422 may receive the IP address information and after processing the IP address information may communicate return information to networking device 420 via communication channel 424. Networking device 420 may communicate the return information to global network 406 via communication channel 416. Global network 406 may communicate the return information to networking device 434 via communication channel 412. Networking device 434 may communicate the return information to processor 436 via communication channel 442. Processor 436 may communicate the return information to GUI 438 via communication channel 444. User may then view the return information on GUI 438.

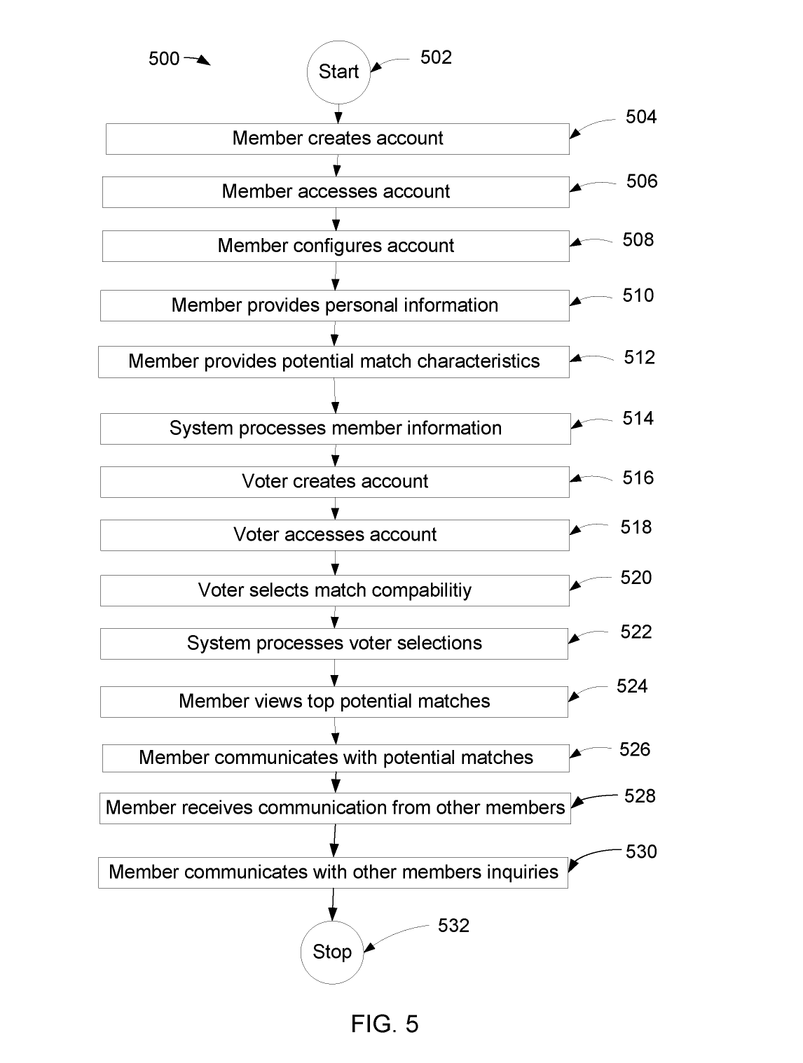

FIG. 5 illustrates an example method for operation of system for interacting with members and voters and for processing associated information, in accordance with an embodiment of the present invention.

A flow chart 500 initiates in a step 502.

Then in a step 504, member creates a new account.

As an example, a prospective member may enter personal information for creating an account. Non-limiting examples of personal information provided include name, address, phone number, credit card details, user account identification and user account password.

Then in a step 506, member accesses account.

As an example, member may enter user account identification and user account password via GUI 438 (FIG. 4).

Referring back to FIG. 5, then in a step 508 member configures account preferences.

As an example, member may configure contact preferences portion 202 (FIG. 2) for allowing other member to communicate who rank in the top 20 potential matches.

Referring back to FIG. 5, then in a step 510 member provides personal information.

As an example, member may provide digital pictures via photos portion 206 (FIG. 2) and textual information via information entry portion 208 (FIG. 2).

Referring back to FIG. 5, then in a step 512 member provides potential match characteristics for other members.

For example, member may configure potential match configuration portion 204 (FIG. 2) for an age range of 18 to 26, a geographical location less than 20 miles and no preference for religion. Furthermore, member may select an importance associated with age, geographical location and religion.

Referring back to FIG. 5, then in a step 514 system processes information entered by member with other members for creating a list of member pairs to be provided to voters for match compatibility selection.

For example, if a first members characteristics (e.g. age, height, etc.) agree or are compatible with a second members characteristics (e.g. age, geographic location, etc.), then first member and second member are noted as a member pair.

Referring back to FIG. 5, then in a step 516 voter creates an account. If the voter does not wish to create an account, the voter may skip the registration process and go to step 520 and vote. It is not required that voters be registered members. Furthermore, it is not required that registered members vote.

As an example, a prospective voter may enter personal information for creating an account. Non-limiting examples of personal information provided include name, address, phone number, credit card details, user account identification and user account password.

Referring back to FIG. 5, then in a step 518 voter accesses account.

As an example, voter may enter user account identification and user account password via GUI 452 (FIG. 4).

Referring back to FIG. 5, then in a step 520 voter selects match compatibility between presented member pairs.

As an example, voter may view GUI presentation 100 as presented in FIG. 1A. Furthermore, voter may select to view additional information as depicted in FIG. 1B.

Referring back to FIG. 5, then in a step 522 system processes voter selections.

As a non-limiting example, system may perform a statistical average for received voter compatibility selections. Furthermore, system may select member pairs with an average greater than the median for presentation to associated members for viewing.

Referring back to FIG. 5, then in a step 524 member views top potential matches.

As an example, member may be view GUI presentation 300 (FIG. 3A). Furthermore, member may selection or mouse-over portions of GUI presentation 300 (FIG. 3A) for viewing information as depicted in FIGS. 3B-C.

Referring back to FIG. 5, then in a step 526 member communicates with potential matches.

As an example, a member may select to chat, text, video teleconference, etc. with another member.

Referring back to FIG. 5, then in a step 528 member receives communication from other members.

As an example, member may be presented with communication via inbox portion 304 (FIG. 3A). Furthermore, member may select a communication message for further viewing as depicted in FIG. 3D.

Referring back to FIG. 5, then in a step 530 member may respond to communicate received from another member.

Referring back to FIG. 5, then in a step execution of flow chart 500 terminates.

FIG. 5 illustrates an example method for operation of system for interaction with members and voters and processing associated information where a member creates an account, accesses the created account, configures the created account, provides personal information for the account, provides characteristics for potential matches, system processes provided information, voter creates an account, voter accesses account, voter selects match compatibility, system processes voter selections, member views top potential matches, member communicates with potential matches, member receives communication from other members and member responds to communication from other members.

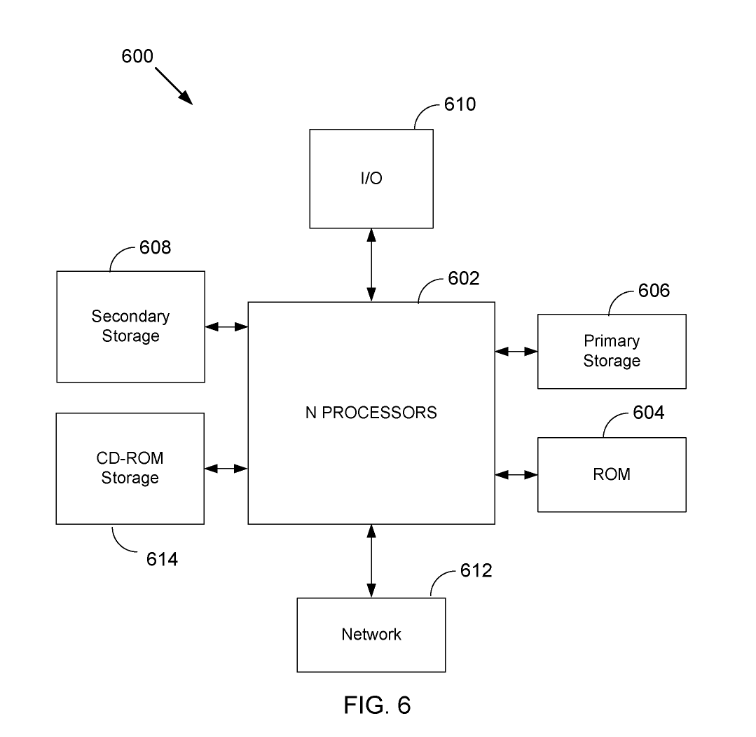

FIG. 6 illustrates a typical computer system that, when appropriately configured or designed, may serve as a computer system 600 for which the present invention may be embodied.

Computer system 600 includes a quantity of processors 602 (also referred to as central processing units, or CPUs) that may be coupled to storage devices including a primary storage 606 (typically a random access memory, or RAM), a primary storage 604 (typically a read only memory, or ROM). CPU 602 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (application Specific Integrated Circuits) or general purpose microprocessors. As is well known in the art, primary storage 604 acts to transfer data and instructions uni-directionally to the CPU and primary storage 606 typically may be used to transfer data and instructions in a bi-directional manner. The primary storage devices discussed previously may include any suitable computer-readable media such as those described above. A mass storage device 608 may also be coupled bi-directionally to CPU 602 and provides additional data storage capacity and may include any of the computer-readable media described above. Mass storage device 608 may be used to store programs, data and the like and typically may be used as a secondary storage medium such as a hard disk. It will be appreciated that the information retained within mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection shown generally as a network 612, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: servers and global communication network.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing a system for matching pairs via a community of voters according to the present invention will be apparent to those skilled in the art. The invention has been described above by way of illustration, and the specific embodiments disclosed are not intended to limit the invention to the particular forms disclosed. For example, the particular implementation of the control devices may vary depending upon the particular type of computing device used. The computing devices described in the foregoing were directed to laptop computing device implementations; however, similar techniques using mobile computing device implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A computer-implemented system comprising:
a database being configured for at least storing information obtained from registered members seeking to be matched with other registered members;
a server executing a computer-executable program being configured for processing information from said database and identifying potential matches of registered members; and
a client executing a computer-executable application being configured for presenting the potential matches and information of the matched members to users electing to vote on a likelihood of successes of the matches, said computer-executable application being further configured for transferring votes to said database to be processed by said computer-executable program for aggregating votes and maintaining statistical values, said computer-executable application being further configured for presenting, to a registered member, identified potential matches for the member and statistical values indicating likelihood of successes of the matches.

2. The computer-implemented system as recited in claim 1, in which the votes are based on a rank order scale.

3. The computer-implemented system as recited in claim 2, in which the identified potential matches are presented to the member in ranked order.

4. The computer-implemented system as recited in claim 1, in which said statistical values dynamically change with received votes.

5. The computer-implemented system as recited in claim 1, in which said computer-executable application further being configured for enabling the member to send communications to an identified potential match.

6. The computer-implemented system as recited in claim 1, in which said computer-executable application further being configured for enabling the member to receive communications from members.

7. The computer-implemented system as recited in claim 6, in which said computer-executable application further being configured for alerting the member of received communications from members.

8. The computer-implemented system as recited in claim 7, in which the communications comprises emails.

9. The computer-implemented system as recited in claim 1, in which information obtained from registered members at least comprises personal information and preferences for characteristics in matches.

10. The computer-implemented system as recited in claim 1, in which information obtained from registered members further comprises preferences for communications.

11. A computer-implemented system comprising:
means for at least storing information obtained from registered members seeking to be matched with other registered members;
means for processing information from said database and identifying potential matches of registered members; and
means for presenting the potential matches and information of the matched members to users electing to vote on a likelihood of successes of the matches, for transferring votes to said database to be processed by said processing means for aggregating votes and maintaining statistical values, and for presenting, to a registered member, identified potential matches for the registered member and statistical values indicating likelihood of successes of the matches.

12. A non-transitory computer-readable storage medium with an executable program stored thereon, wherein the program instructs a processor to perform the following steps:
obtaining information from registered members seeking to be matched with other registered members for storage on a database where a server executing a computer-executable program is configured for processing information from said database and identifying potential matches of registered members;
presenting potential matches and information of the matched registered members to users electing to vote on a likelihood of successes of the matches;
transferring votes to said database to be processed by said server for aggregating votes and maintaining statistical values; and
presenting, to a registered member, identified potential matches for the registered member and statistical values indicating likelihood of successes of the matches.

13. The program instructing the processor as recited in claim 12, in which the votes are based on a rank order scale.

14. The program instructing the processor as recited in claim 13, in which the identified potential matches are presented to the member in ranked order.

15. The program instructing the processor as recited in claim 12, in which said statistical values dynamically change with received votes.

16. The program instructing the processor as recited in claim 12, further comprising the step of enabling the member to communicate to an identified potential match.

17. The program instructing the processor as recited in claim 12, further comprising the step of enabling the member to receive communications from members.

18. The program instructing the processor as recited in claim 17, further comprising the step of alerting the member of received communications from members.

19. The program instructing the processor recited in claim 12, in which information obtained from registered members at least comprises personal information and preferences for characteristics in matches.

20. The program instructing the processor as recited in claim 12, in which information obtained from registered members further comprises preferences for communications.
